(19) United States
(12) Patent Application Publication
(10) Pub. No.: US 2016/0209539 A1
(43) Pub. Date: Jul. 21, 2016

(54) Method for Separating Multi-Modal Acoustic Measurements for Evaluating Multilayer Structures

(71) Applicant: SCHLUMBERGER TECHNOLOGY CORPORATION, Sugar Land, TX (US)

(72) Inventors: Jean-Luc Le Calvez, Orsay (FR); Thilo Michael Brill, Chatou (FR)

(21) Appl. No.: 14/940,500

(22) Filed: Nov. 13, 2015

(30) Foreign Application Priority Data
Nov. 14, 2014 (EP) 14290347.5

(51) Int. Cl. G01V 1/50

(52) U.S. Cl. CPC G01V 1/50; G01V 2210/6242

(57) ABSTRACT

Techniques involve methods and systems for separating leaky-Lamb modes to evaluate cylindrically layered structures. Embodiments involve receiving acoustic cement evaluation data from one or more acoustic downhole tools used over a depth interval in a well having a casing. The acoustic cement evaluation data includes leaky-Lamb wave measurements measured from the acoustic downhole tools. Embodiments also involve determining an extensional mode component and a flexural mode component of the leaky-Lamb wave measurements and determining a flexural wave attenuation based on the flexural mode component of the leaky-Lamb wave measurement. In some embodiments, the extensional and flexural mode components can be determined using mode decomposition technique. Further, some embodiments involve constructing dictionaries for the extensional and flexural mode components and representing the leaky-Lamb wave measurement as a weighted sum based on the dictionaries and reconstruct a flexural wave attenuation based on the weighted sum.

### BACKGROUND

The present invention relates generally to a method and apparatus for acoustical imaging of cased wells. More particularly, the present invention relates to techniques for separating multi-modal acoustic measurements for evaluating multilayer structures.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions.

Effective diagnosis of well zonal isolation has become increasingly important and with more rigorous government regulations. These regulations call for oil and gas operators to deliver and maintain wells with pressure seals that prevent uncontrolled flow of subterranean formation fluids such as natural gas, saline, and hydrocarbon fluids to leak into the atmosphere or into an underground formation. The diagnosis is typically performed following a cementation job or during the life of a well or at the end of its life before plug and abandonment.

Acoustic measurements are widely used to provide a diagnosis of the condition of the placed cement. Acoustics are affected by several mechanisms ranging from structural (e.g., tool position within the casing, geometry of the casing within the hole, geometry of the hole, etc.) to intrinsic material parameters (the bulk properties of annular material, casing, formation, borehole fluid) as well as to interfacial conditions (the bond of the cement to casing and to formation). When parameterized accordingly, these conditions yield a large number of previously unknown information such as cement wave velocities and bonding parameters.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of this disclosure relate to various systems, methods, and devices for evaluating an annular fill material in a well. Thus, the systems, methods, and devices of this disclosure describe various ways of using acoustic cement evaluation data obtained from acoustic downhole tools to evaluate annular integrity. In one example, a method includes receiving acoustic cement evaluation data into a data processing system. The acoustic cement evaluation data is obtained from one or more acoustic downhole tools used over a depth interval in a well having a casing. The acoustic cement evaluation data includes leaky-Lamb wave measurements measured from the one or more acoustic downhole tools. The method includes applying a mode decomposition technique on the leaky-Lamb wave measurements, where the mode decomposition technique includes determining an extensional mode component of the leaky-Lamb wave measurements and determining a flexural mode component of the leaky-Lamb wave measurement. The method further includes determining a flexural wave attenuation based on the flexural mode component of the leaky-Lamb wave measurement.

Some embodiments involve receiving acoustic cement evaluation data into a data processing system. The acoustic cement evaluation data is obtained from one or more acoustic downhole tools used over a depth interval in a well having a casing. The acoustic cement evaluation data includes leaky-Lamb wave measurements measured from the one or more acoustic downhole tools. The method includes determining an extensional mode component of the leaky-Lamb wave measurement, determining a flexural mode component of the leaky-Lamb wave measurement, and constructing a dictionary for each of the extensional mode component and the flexural mode component, where the dictionaries include parameters related to the casing and the one or more acoustic downhole tools. The method further includes representing the leaky-Lamb wave measurement as a weighted sum based on the dictionaries and reconstructing a flexural wave attenuation based on the weighted sum.

In another example, a computer-readable media includes instructions to receive receive acoustic cement evaluation data from one or more acoustic downhole tools used in a depth interval of a well having a casing, where the acoustic cement evaluation data comprises Lamb wave measurements from the one or more acoustic downhole tools, determine an extensional mode component of the Lamb wave measurement, determine a flexural mode component of the Lamb wave measurement, and determine a flexural wave attenuation based on the flexural mode component of the Lamb wave measurement. In some embodiments, the instructions further comprise instructions to apply a mode decomposition technique on the Lamb wave measurements and apply an iterative adjustment to iteratively adjust the flexural wave attenuation. In some embodiments, the instructions further comprise instructions to construct a dictionary for each of the extensional mode component and the flexural mode component, wherein the dictionaries comprise parameters related to the casing and the one or more acoustic downhole tools and represent the Lamb wave measurement as a weighted sum based on the dictionaries and reconstruct a flexural wave attenuation based on the weighted sum.

Various refinements of the features noted above may be undertaken in relation to various aspects of the present disclosure. Further features may also be incorporated in these various aspects as well. These refinements and additional features may be determined individually or in any combination. For instance, various features discussed below in relation to the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic diagram of a system for verifying proper cement installation and/or zonal isolation of a well, in accordance with an embodiment;

FIG. 2 is a block diagram of an acoustic downhole tool to obtain acoustic cement evaluation data relating to material behind casing of the well, in accordance with an embodiment;

FIG. 3 is a block diagram of another acoustic downhole tool to obtain acoustic cement evaluation data relating to material behind casing of the well, in accordance with an embodiment;

FIG. 4 is a block diagram of an acoustic downhole tool obtaining acoustic cement evaluation data in a free pipe condition, in accordance with an embodiment;

FIG. 5 are plots waveforms received from near and far receivers with flexural, extensional, specular, and total signals, in accordance with an embodiment;

FIG. 6 are schematic representations of model calculations and experimental results over a range of transmitter-receiver spacings, in accordance with an embodiment;

FIG. 7 are schematic representations of waveforms over a range of transmitter-receiver spacings, with flexural and extensional contributions, in accordance with an embodiment;

FIG. 8 are plots of phase velocity and group velocity with respect to frequency for both flexural and extensional modes, in accordance with an embodiment;

FIG. 9 are plots of leaky Lamb wave attenuation with respect to frequency in plates of different thicknesses for flexural and extensional modes, in accordance with an embodiment;

FIG. 10 are plots representing present mode decomposition processing with flexural and extensional processing results, in accordance with an embodiment;

FIG. 11 are plots representing present mode decomposition with flexural and extensional processing for two different receivers, in accordance with an embodiment;

FIG. 12 is a plot representing present mode decomposition processing for synthetic data with respect to fluid acoustic impedance, in accordance with an embodiment;

FIG. 13 are plots of cost function based on the cumulative sum of squares a waveform, in accordance with an embodiment;

FIG. 14 are plots of cost function based on the windowed sum of squares of a waveform, in accordance with an embodiment;

FIG. 15 are plots representing the zeroth-order anti-symmetric mode A0, the zeroth-order symmetric mode S0, and their sum, in accordance with an embodiment;

FIG. 16 is a plot of the zeroth-order anti-symmetric mode A0 and the zeroth-order symmetric mode S0, in accordance with an embodiment;

FIG. 17 is a plot of the zeroth-order anti-symmetric mode A0 and the zeroth-order symmetric mode S0 over frequency with respect to phase velocity, in accordance with an embodiment; and

FIG. 18 is a plot representing decomposition of lamb mode signals in accordance with an embodiment.

### DETAILED DESCRIPTION

One or more specific embodiments of the present disclosure will be described below. These described embodiments are just examples of the presently disclosed techniques. Additionally, in an effort to provide a concise description of these embodiments, features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would still be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

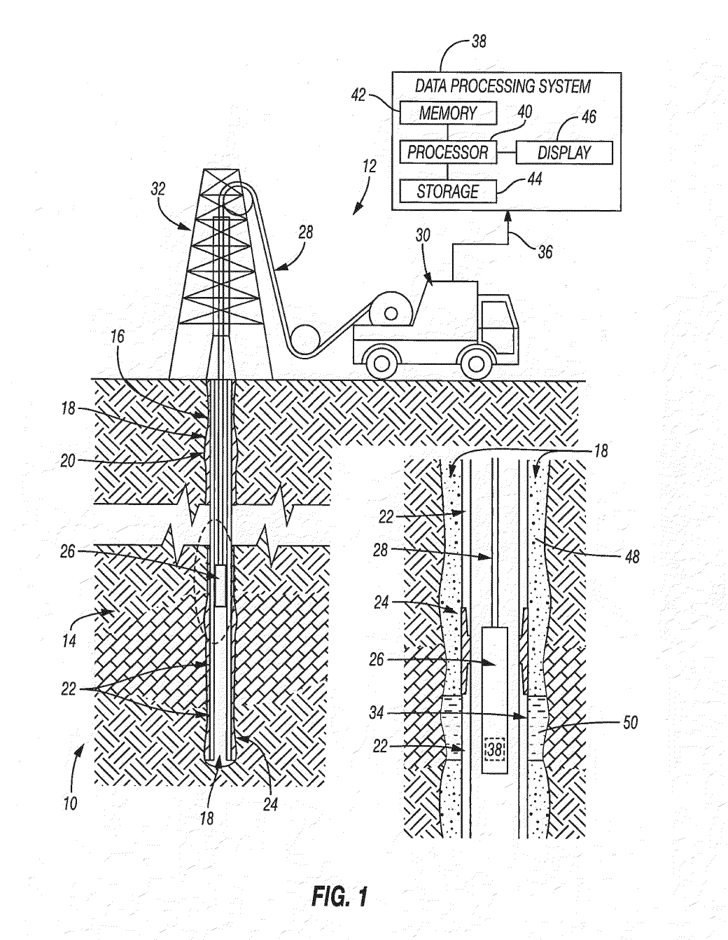

Ultrasonic measurements are commonly used to evaluate cement properties and well integrity. Ultrasonic measurements may be transmitted, received, and evaluated using various techniques. FIG. 1 schematically illustrates a system 10 for evaluating cement behind casing in a well. In particular, FIG. 1 illustrates surface equipment 12 above a geological formation 14. In the example of FIG. 1, a drilling operation has previously been carried out to drill a wellbore 16. In addition, an annular fill 18 (e.g., cement, resin, or any other material for filling the annulus 20) has been used to seal an annulus 20—the space between the wellbore 16 and casing joints 22 and collars 24—with cementing operations.

As seen in FIG. 1, several casing joints 22 (also referred to below as pipes or casing 22) are coupled together by the casing collars 24 to stabilize the wellbore 16. The casing joints 22 represent lengths of pipe, which may be formed from steel or similar materials. In one example, the casing joints 22 each may be approximately 13 m or 40 ft long, and may include an externally threaded (male thread form) connection at each end. A corresponding internally threaded (female thread form) connection in the casing collars 24 may connect two nearby casing joints 22. Coupled in this way, the casing joints 22 may be assembled to form a casing string to a suitable length and specification for the wellbore 16. The casing joints 22 and/or collars 24 may be made of carbon steel, stainless steel, or other suitable materials to withstand a variety of forces, such as collapse, burst, and tensile failure, as well as chemically aggressive fluid.

The surface equipment 12 may carry out various well logging operations to detect conditions of the wellbore 16. The well logging operations may measure parameters of the geological formation 14 (e.g., resistivity or porosity) and/or the wellbore 16 (e.g., temperature, pressure, fluid type, or fluid flowrate). Other measurements may provide acoustic cement evaluation data (e.g., flexural attenuation and/or acoustic impedance) that may be used to verify the cement installation and the zonal isolation of the wellbore 16. One or more acoustic logging tools 26 may obtain some of these measurements.

The example of FIG. 1 shows the acoustic logging tool 26 being conveyed through the wellbore 16 by a cable 28. Such a cable 28 may be a mechanical cable, an electrical cable, or an electro-optical cable that includes a fiber line protected against the harsh environment of the wellbore 16. In other examples, however, the acoustic logging tool 26 may be conveyed using any other suitable conveyance, such as coiled tubing. The acoustic logging tool 26 may be, for example, an UltraSonic Imager (USI) tool and/or an Isolation Scanner tool by Schlumberger Technology Corporation. The acoustic logging tool 26 may obtain measurements of acoustic impedance from ultrasonic waves and/or flexural attenuation. For instance, the acoustic logging tool 26 may obtain a pulse echo measurement that exploits the thickness mode (e.g., in the manner of an ultrasonic imaging tool) or may perform a pitch-catch measurement that exploits the flexural mode (e.g., in the manner of an imaging-behind-casing tool). These measurements may be used as acoustic cement evaluation data in a solid-liquid-gas (SLG) model map to identify likely locations where solid, liquid, or gas is located in the annulus 20 behind the casing 22.

The acoustic logging tool 26 may be deployed inside the wellbore 16 by the surface equipment 12, which may include a vehicle 30 and a deploying system such as a drilling rig 32. Data related to the geological formation 14 or the wellbore 16 gathered by the acoustic logging tool 26 may be transmitted to the surface, and/or stored in the acoustic logging tool 26 for later processing and analysis. As will be discussed further below, the vehicle 30 may be fitted with or may communicate with a computer and software to perform data collection and analysis.

FIG. 1 also schematically illustrates a magnified view of a portion of the cased wellbore 16. As mentioned above, the acoustic logging tool 26 may obtain acoustic cement evaluation data relating to the presence of solids, liquids, or gases behind the casing 22. For instance, the acoustic logging tool 26 may obtain measures of acoustic impedance and/or flexural attenuation, which may be used to determine where the material behind the casing 22 is a solid (e.g., properly set cement) or is not solid (e.g., is a liquid or a gas). When the acoustic logging tool 26 provides such measurements to the surface equipment 12 (e.g., through the cable 28), the surface equipment 12 may pass the measurements as acoustic cement evaluation data 36 to a data processing system 38 that includes a processor 40, memory 42, storage 44, and/or a display 46. In other examples, the acoustic cement evaluation data 36 may be processed by a similar data processing system 38 at any other suitable location. For example, in some embodiments, all or a portion of the data processing system 38 may be coupled to the acoustic tool 26, and some or all of the cement evaluation data processing may occur in the wellbore 16.

The data processing system 38 may collect the acoustic cement evaluation data 36 and determine well integrity based on processing of the data 36. For example, the acoustic cement evaluation data 36 may be processed to derive certain characteristics of the annular fill 18, such as to determine an acoustic impedance of the annular fill. Additionally, the data processing system 38 may integrate multiple types of acoustic cement evaluation data 36, including multiple modes of acoustic data 36 obtained with different types of acoustic tools 26. To do this, the processor 40 may execute instructions stored in the memory 42 and/or storage 44. As such, the memory 42 and/or the storage 44 of the data processing system 38 may be any suitable article of manufacture that can store the instructions. The memory 42 and/or the storage 44 may be ROM memory, random-access memory (RAM), flash memory, an optical storage medium, or a hard disk drive, to name a few examples. The display 46 may be any suitable electronic display that can display the logs and/or other information relating to classifying the material in the annulus 20 behind the casing 22.

In this way, the acoustic cement evaluation data 36 from the acoustic logging tool 26 may be used to determine whether the annular fill 18 has been installed as expected. In some cases, the acoustic cement evaluation data 36 may indicate that the cement of the annular fill 18 has a generally solid character (e.g., as indicated at numeral 48) and therefore has properly set. In other cases, the acoustic cement evaluation data 36 may indicate the potential absence of cement or that the annular fill 18 has a generally liquid or gas character (e.g., as indicated at numeral 50), which may imply that the cement of the annular fill 18 has not properly set. For example, when the indicate the annular fill 18 has the generally liquid character as indicated at numeral 50, this may imply that the cement is either absent or was of the wrong type or consistency, and/or that fluid channels have formed in the cement of the annular fill 18.

In some embodiments, processing acoustic cement evaluation data 36 may involve separating different modes of acoustic measurements to provide more accurate cement evaluation. For example, in some embodiments, the data processing system 38 may be suitable for separating the flexural mode from mixed leaky modes.

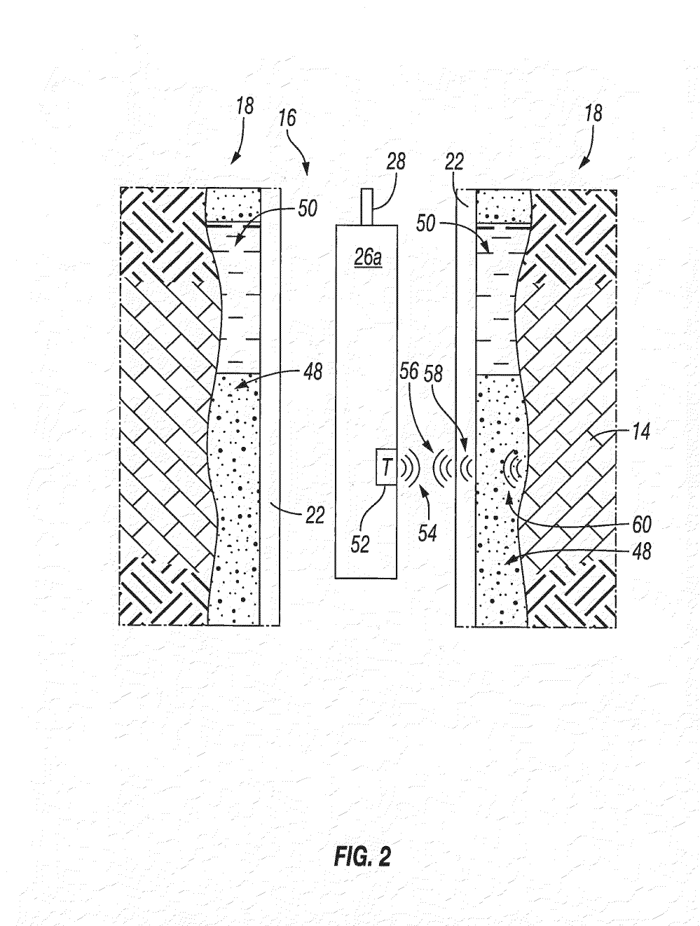

FIG. 2 provides a general example of the operation of the acoustic logging tool 26a in the wellbore 16. The acoustic logging tool 26a may be suitable for operating in a “pulse echo” technique involves using a single trans-receiver that pulses an acoustic beam at normal incidence to the casing inner wall and receives the return echo energy. Specifically, a transducer 52 in the acoustic logging tool 26 may emit acoustic waves 54 out toward the casing 22. Reflected waves 56, 58, and 60 may correspond to interfaces at the casing 22, the annular fill 18, and the geological formation 14 or an outer casing, respectively. The reflected waves 56, 58, and 60 may vary depending on whether the annular fill 18 is of the generally solid character 48 or the generally liquid or gas character 50. The acoustic logging tool 26 may use any suitable number of different techniques, including measurements of acoustic impedance from ultrasonic waves and/or flexural attenuation. When one or more of these measurements of acoustic cement evaluation data are obtained, they may be integrated and/or processed to determine characteristics of the annular fill 18.

In some embodiments, at normal incidence and in steel casings that are approximately 15 mm-thick and thinner, a casing thickness mode is excited in the typical frequency range of approximately 200-500 kHz and leads to a resonant response for the received waveform. This casing mode corresponds to the casing Lamb mode. In some embodiments, an inversion technique may estimate the decaying resonance and associate it with an acoustic impedance as a function of the product of compressional wavespeed and density for the annular fill material. In thicker casings (>15 mm), the received signal is seen to be made of temporal isolated echoes arising from multiple resolvable reflections occurring at the casing walls. Processing of the amplitudes of these echoes also leads to an estimation of the cement acoustic impedance Zcmt. The pulse-echo technique may typically be used to evaluate the immediate casing-cement region.

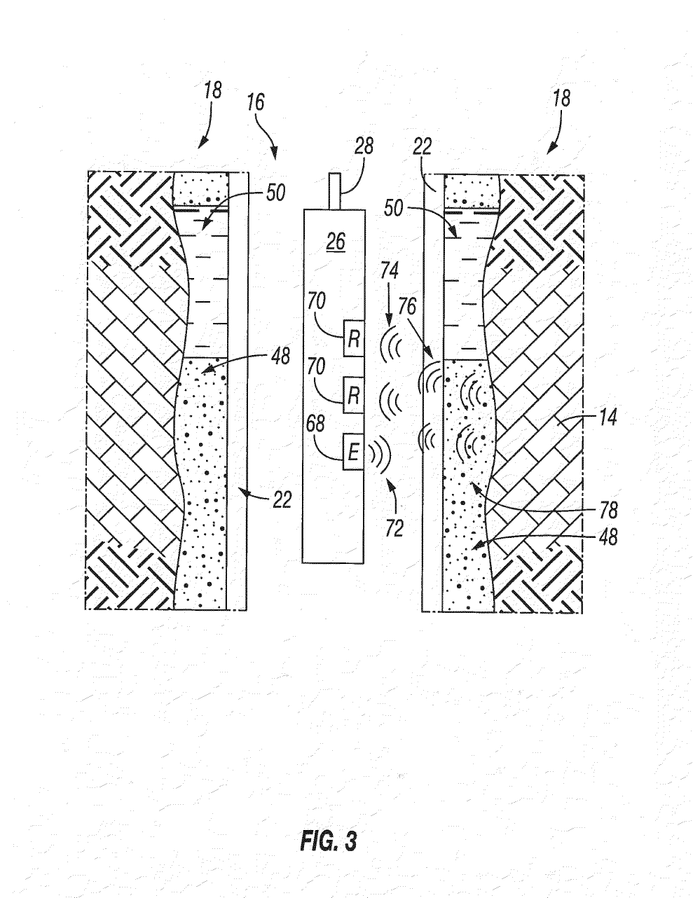

FIG. 3 provides another example embodiment of the acoustic logging tool 26b having an emitter 68 and a pair of receiver transducers 70. The acoustic logging tool 26b may be suitable for operating in a “pitch-catch” technique using separate transmitters and receivers, where one or more transmitters and receivers are oriented to transmit acoustic signals and receive signal reflections. Specifically, the emitter 68 in the acoustic logging tool 26a may emit acoustic energy 72 out toward the casing 22 resulting in reflected waves 74, 76, and 78. In the embodiments shown in FIG. 3, the emitted energy excites a predominantly zeroth-order asymmetric mode (also referred to as flexural mode). As in the embodiment described above, the acoustic waves 72 propagate via transmission into both sides of the casing wall 22. The transmission in the casing annulus depends on the material on the outer side of the casing wall with a different amount of energy leak inside the annulus. The acoustic logging tool embodiment depicted in FIG. 3 may use measurements of acoustic impedance from flexural attenuation. The different distance from the emitter 68 and the two receiver transducers 70 and the energy leak induce different amplitudes on the measured acoustic pressure. In some embodiments, this arrangement may be used to evaluate deeper than the immediate casing-cement region. Furthermore, depending on the orientation angle of the transmitting and receiving transducers, one of more than one Lamb modes of the casing can be excited and detected. The angles and separation and placement of the transducers 70 may be suitable for exciting and detecting the casing flexural mode which is identified as the lowest antisymmetric Lamb mode (A₀).

In some embodiments, the flexural attenuation includes a peak amplitude associated with the echo propagating in the casing as it decays from the first receiver to the second. The flexural measurement may be a function of acoustic impedance on both sides of the casing. Determining acoustic impedance may be used to characterize the integrity of the annular fill material in the annulus behind the casing, such as by discriminating cement from liquid and gas. In some embodiments, determining the acoustic impedance may involve calibrating the transducers based on a separate flexural attenuation measurement in a fluid-immersed (also referred to as “free-pipe”) condition.

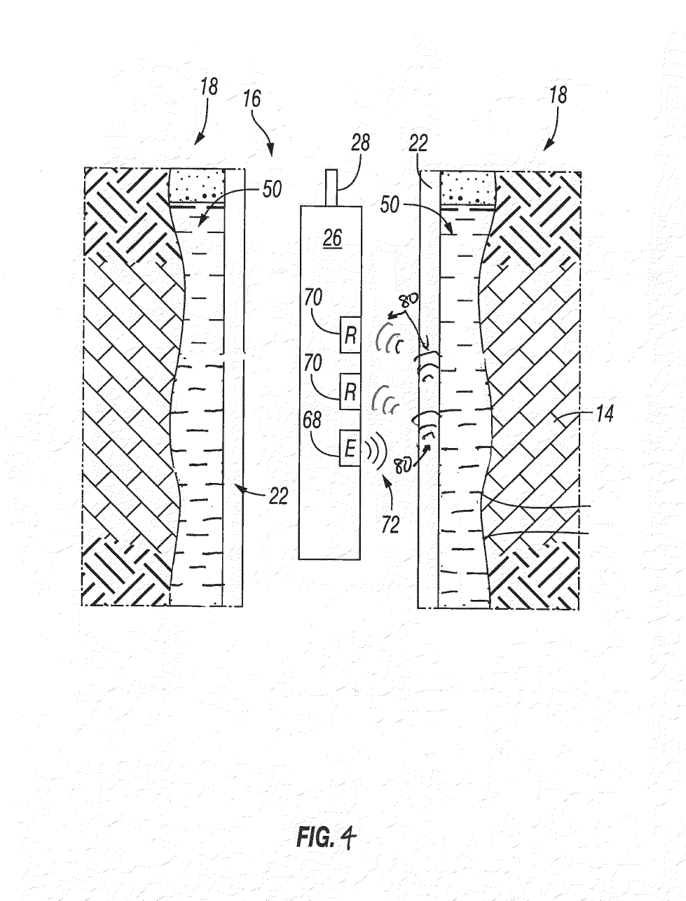

FIG. 4 is an illustration representing the acoustic logging tool 26b in a free-pipe condition, where the annular fill 18 is of generally liquid or gas character 50. The measurement of flexural attenuation in such a free-pipe condition may also be described by a leaky-Lamb wave model. The effect of the fluid on the phase velocity of a leaky-Lamb wave may be negligible to a high degree of accuracy as long as the density of the medium supporting the Lamb wave is sufficiently higher than that of the fluid. The main effect of the fluid is on the imaginary part of the Lamb wave vector, related to the mode attenuation. To first order, the Lamb wave attenuation scales are proportional to the acoustic impedance of the fluid encompassing the solid. Furthermore, the total attenuation due to fluids on both sides of the solid is closely matched by the sum of attenuations given by individual fluids on each side of the solid. This permits a formal subtraction of the known attenuation contribution of the inner logging fluid from the total measured attenuation in order to estimate the contribution by the medium behind the casing by itself.

As seen in FIG. 4, the transmitter 68 may insonify the casing 22 with acoustic waves 72, thereby exciting leaky Lamb waves. These leaky Lamb waves 80 propagate upward along the casing 22 while radiating acoustic waves back into the fluid on both sides of the casing. The receivers 70 may receive the reemitted waves 80, and the waveform signals received at each of the receivers 70 may be used for processing. As the tool 26b logs up the casing 22, the tool 26b may spin inside the casing 22 around the tool axis and thus allows for imaging the borehole environment.

In accordance with the present techniques, ultrasonic guided Lamb waves are a major tool for evaluating cylindrically layered fluid-loaded elastic structures. When used in fluid-immersed free-pipe conditions, and in a frequency×thickness product range (such as in the range of approximately 1 to 3 MHz mm, in some embodiments), the fundamental anti-symmetric flexural and symmetric extensional Lamb modes may be selectively excited by a suitable combination of broadband pulse and oblique incidence angle. Both modes exhibit dispersion but the flexural mode may have group velocity is only weakly frequency dependent for the frequency×thickness product range of interest and can therefore be detected after propagation over relatively long distances. The determination of flexural attenuation in pitch-catch configuration with one transmitter and two receivers is particularly adapted to the evaluation of elastic properties of an inaccessible medium outside of a pipe. However, the highly dispersive co-excited extensional mode interferes with the flexural mode and complicates the determination of the flexural attenuation.

Embodiments involve techniques for separating the flexural mode from mixed leaky modes. One or more embodiments involve an asymptotic forward model describing the interaction of Gaussian ultrasonic transducer beams with loaded cylindrically layered elastic structures. One embodiment involves a mode decomposition algorithm, based on estimates of the complex mode dispersion relations. Another embodiment uses the differences in the frequency dependence of the Lamb waves to build mode dictionaries and to recover the flexural wave by a pursuit algorithm.

An embodiment using a mode decomposition algorithm involves disentangling the flexural waveform from the extensional waveform such that the flexural attenuation can be more accurately determined. The mode decomposition technique may be particularly suitable for fluid-immersed casings, or free-pipe conditions, as it is based on the 2-½ D with asymptotic evaluation code. To expand the analysis to the cemented casings, an ad hoc attenuation correction is applied based on the initial leaky-wave attenuation estimate from conventional processing

In applying the mode decomposition technique, a dual mode leaky Lamb wave signals in pitch-catch geometry in fluid immersed casings may be assumed to have two transmitter-receiver spacings x₁ and x₂. Two waveforms are thus measured, each characterized by the dispersive propagators of the fundamental symmetric S0 mode (extensional mode) and the fundamental anti-symmetric A0 (flexural mode). Some attributes, such as higher order modes, the casing curvature, the specular reflection, the effect of fluid attenuation, and noise, may be ignored in some techniques. However, in one or more embodiments, one or more of such attributes may be characterized and/or processed, as will be further discussed below.

The time-domain signal can be represented by a Fourier transform of the two plane-wave modes propagating in positive x-direction with amplitudes (or excitabilities') A₀ and S₀, as represented by Eq 1 below:

yᵢ(xᵢ,t)=∫_{-∞}^{∞}dωF(ω){A₀e^{i(ωt-k}^{_{A0}}^{x}^{ᵢ}⁾+S₀e^{i(ωt-k}^{_{S0}}^{x}^{ᵢ}⁾} Eq. 1

where k_{A0} and k_{S0} are the complex (dispersive) wavevectors of the flexural and extensional modes, respectively. These modes are convoluted with a sensor pulse excitation spectrum F(ω). The dispersive wavevectors of the Lamb modes can be described by

$${k}_{λ} = \frac{ω}{{c}_{λ} ( ω )} + i {α}_{λ} ( ω ) \qquad Eq . 2$$

where c_{λ}(ω) is the phase velocity of a given mode λ and α_{λ}(ω) is the mode attenuation. In the Fourier domain (and suppressing the common factor e^{iωt}) the two receiver signals may be rewritten as the following system of equations

$$[ \begin{matrix}{y}_{1} = {a}_{0} {e}^{- i {k}_{A 0} {x}_{1}} + {S}_{0} {e}^{- i {k}_{S 0} {x}_{1}} \\ {y}_{2} = {a}_{0} {e}^{- i {k}_{A 0} {x}_{2}} + {S}_{0} {e}^{- i {k}_{S 0} {x}_{2}}\end{matrix} \qquad Eq . 3$$

where an a priori knowledge of the complex wavevectors k_{A0} and k_{S0} may be assumed. Furthermore, the pulse excitation spectrum F(ω) in the excitabilities a₀=F A₀ and S₀=F S₀ are included. Eventually, the ratios of flexural wave amplitudes may be calculated at the two different spacings, and the common pulse excitation spectrum F(ω) will cancel out.

The receiver-to-receiver spacing is represented as TR=x₂−x₁ and without loss of generality set the near receiver spacing at the x-axis coordinate origin.

$$[ \begin{matrix}{y}_{1} = {a}_{0} + {s}_{0} \\ {y}_{2} = {a}_{0} {e}^{- i {k}_{A 0} TR} + {s}_{0} {e}^{- i {k}_{S 0} TR}\end{matrix} \qquad Eq . 4$$

The frequency-dependent mode amplitudes a₀ and s₀ may be solved for in the Fourier domain.

$$[ \begin{matrix}{a}_{0} = \frac{{y}_{1} - {e}^{i {k}_{S 0} TR} {y}_{2}}{1 - {e}^{- i ( {k}_{A 0} - {k}_{S 0} ) TR}} \\ {S}_{0} = \frac{{y}_{1} - {e}^{i {k}_{A 0} TR} {y}_{2}}{1 - {e}^{i ( {k}_{A 0} - {k}_{S 0} ) TR}}\end{matrix} \qquad Eq . 5$$

Having decomposed each signal yᵢ into two constituents which propagate as a₀e^{-ik}^{_{A0}}^{x} and s₀e^{-ik}^{_{S0}}^{x} based on the imposed dispersion relations, the flexural attenuation may be determined. The real part of the Fourier transforms of each mode may be calculated to obtain a time-domain signal for the near and the far receiver.

yᵢ(xᵢ,t)=Re∫_{-∞}^{∞}dωFa₀e^{i(ωt-k}^{_{A0}}^{x}^{ᵢ}⁾ i∈{1,2}. Eq. 6

Conventional processing typically determines the ratios between peak magnitudes of the Hilbert transforms of the far and the near receiver signal. Over a given bandwidth, this reduces essentially to calculating

$${Attn}_{A 0} = ( \frac{20}{TR} ) \frac{imag [ {k}_{A 0} ( f ) ]}{ln ( 10 )} = \frac{20}{TR ln ( 10 )} {α}_{A 0} [ \frac{dB}{m} ] \qquad Eq . 7$$

This may be the result as long as the assumptions above hold. In general, the neglected contributions of noise and specular reflections will introduce additional terms in Equation 1 Error! Reference source not found. with the consequence that the two decomposed modes A₀ and S₀ will obey the imposed dispersion relations of Equation 2, but each decomposed waveform will contain spectral components introduced by any additional terms.

In some embodiments, a forward mode may be implemented. Such a forward mode may allow (possibly in real time, in embodiments) the calculation of dispersion relations for the individual modes in Equation 2. A fast planar asymptotic model is may be used. The approximation of cylindrical casing geometry by a planar asymptotic model may be applied at least for the larger casing diameters. Additionally, real-axis integration codes for planar and cylindrical geometries may also be applied.

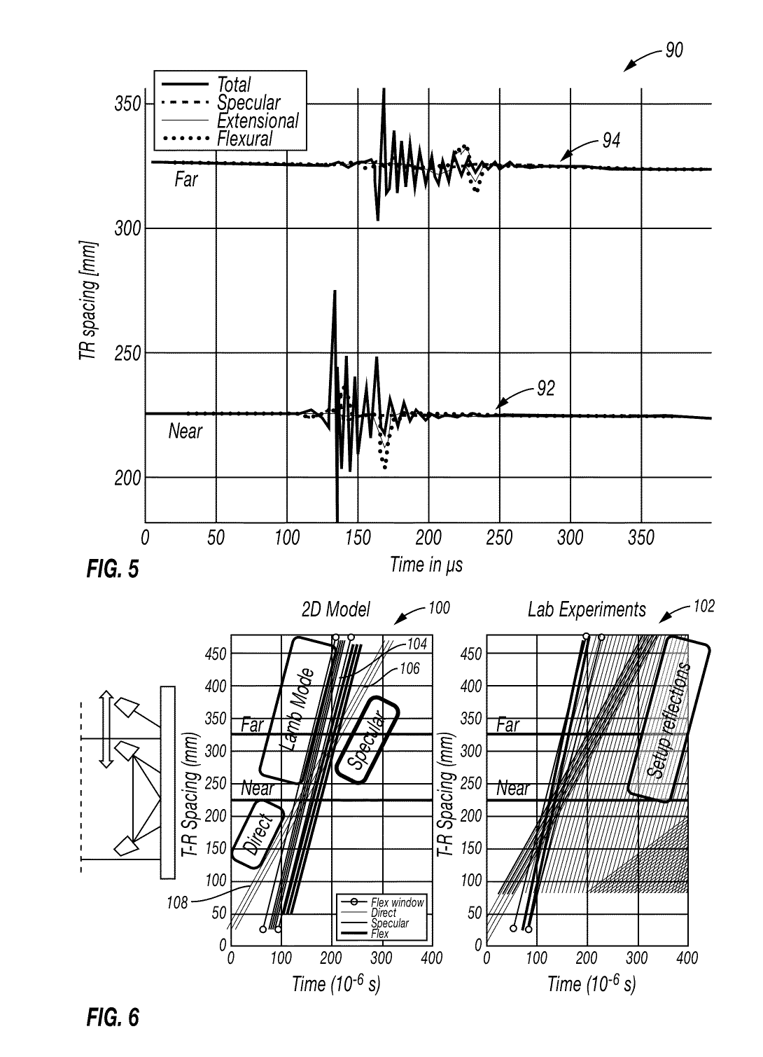

In the plot 90 of FIG. 5, near waveforms 92 and far waveforms 94 have been calculated with the fast asymptotic model. The waveforms 92, 94 represent the contributions to a total signal by flexural (A0), extensional (S0), and specular reflection. In some embodiments, the transmitter may operate at a suitable frequency depending on the wellbore conditions, such as the thickness of the casing. For example, a transmitter may operate at approximately 125 kHz for casings approximately 1 inch thick. The determination of the flexural attenuation by itself is hampered by the presence of a significant contribution of the extensional at the flexural peak.

The illustration of FIG. 6 juxtaposes model calculations 100 with experimental results 102 for a large range of transmitter-receiver spacings. A dominating flexural Lamb wave 104, as well as specular reflections 106 and an experimental direct arrival through the water 108 are depicted. The experimental data 102 includes early arriving wave groups.

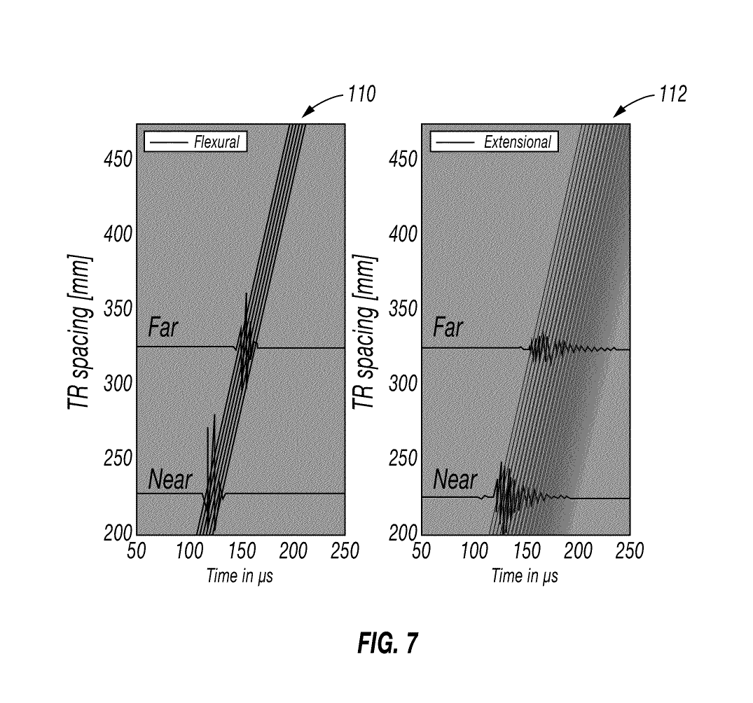

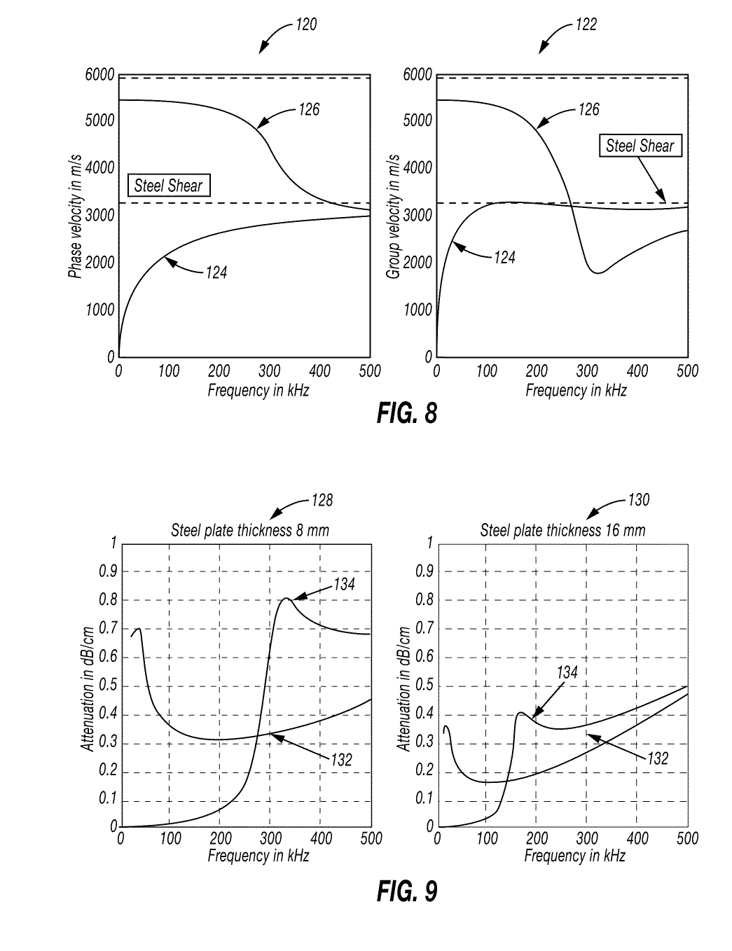

FIG. 7 represents calculations of waveforms for a range of transmitter-receiver spacings in a 20 mm thick plate, where the contributions from the flexural 110 are shown separately from the extensional contributions 112. Two example near and far waveforms (e.g., from a near and far receiver 70 with respect to the emitter 68) are indicated. It is important to recognize that the flexural wave 110 exhibits relatively little dispersion of the group velocity and therefore remains temporally compact for a long distance of propagation. The extensional wave 112 which overlaps in time with the flexural wave, is however relatively dispersive with a low-frequency early arrival, followed by an extended wave group at higher frequencies. This behavior is borne out by the dispersion relation of the modes (as in FIGS. 8 and 9).

As shown in the plot of FIG. 8, the phase velocity 120 and group velocity 122 versus frequency for flexural 124 and extensional 126 modes, here for an 8 mm thick plate. The horizontal axis scales as the product of thickness and frequency. This means that at larger thickness the interference of flexural and extensional modes takes place inside the tool operating frequency (125 kHz to 250 kHz) and separation by frequency-selection and/or windowing becomes impractical. This case is being addressed with the present processing solution which is designed to disentangle the two modes.

In the plot of FIG. 9, leaky Lamb wave attenuation [dB/cm] versus frequency in plates of 8 mm 128 and 16 mm thickness 130 for flexural 132 and extensional 134 modes. The horizontal axis scales as the product of thickness and frequency. The attenuation, as depicted in FIG. 9, may also be inversely proportional to the thickness.

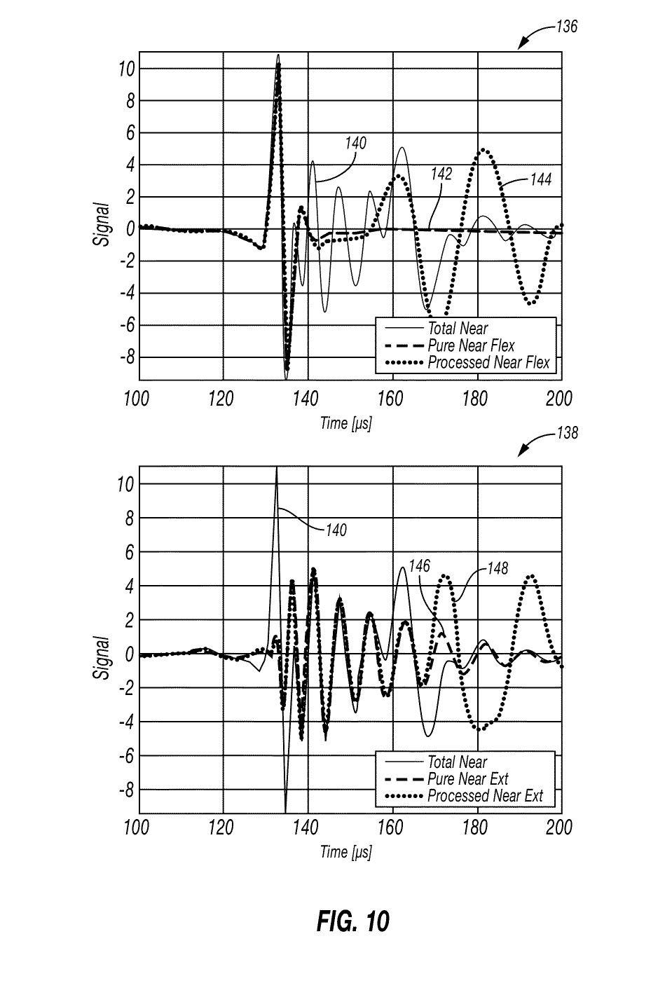

The plots illustrated in FIG. 10 show the results of present mode decomposition processing for the synthetic near RX signal of FIG. 5 (approximately 1 inch thick water-immersed plate) which include a specular signal. The presence of the specular signal is not treated by the mode-decomposition approach and leads to errors. Each of the plots 136 and 138 show the total signal 140. The plot 136 shows the theoretical flexural wave 142 and the processing result 144. The plot 138 shows the theoretical extensional wave 146 and the processing result 148. In some embodiments, as shown in plot 136, the flexural amplitude may be relatively accurately reconstructed, as artifacts resulting from the specular contribution arrive later in time and can be eliminated by appropriate windowing.

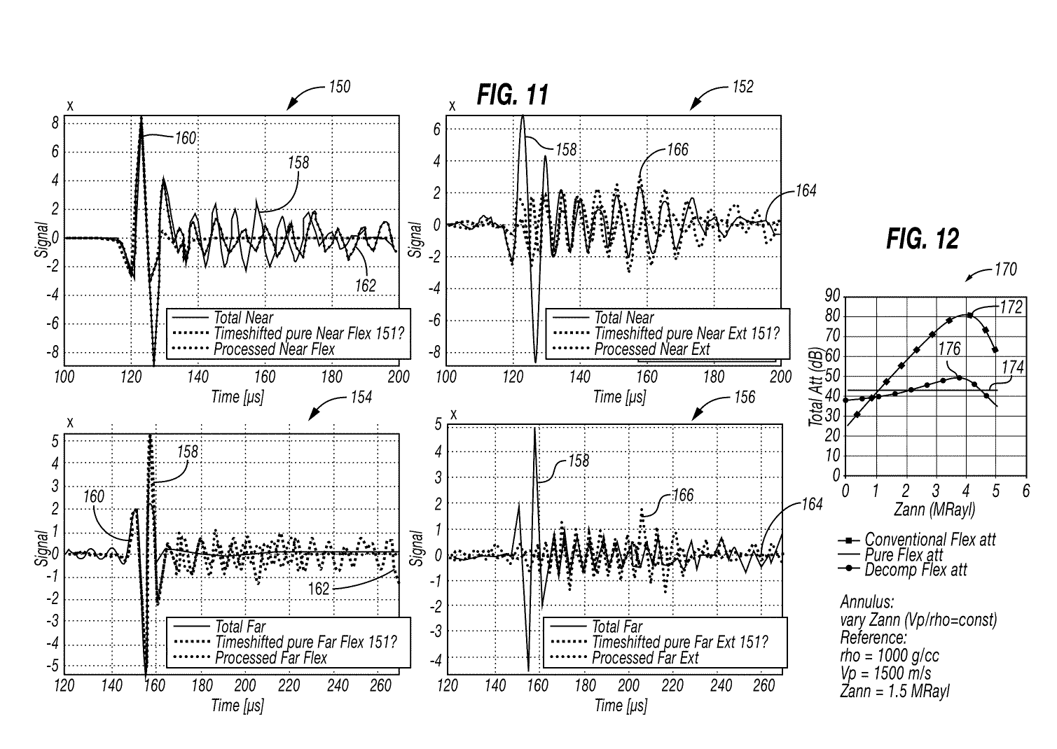

The plots of FIG. 11 show the results of the present mode decomposition processing for experimental results in a 20 mm thick water-immersed casing. In FIG. 11, plot 150 is a response for the near receiver in flexural mode, plot 152 is a response for the near receiver in extensional mode, plot 154 is a response for the far receiver in flexural mode, and plot 156 is a response for the far receiver in extensional mode. Each of the plots 150, 152, 154, 156 shows the total signal 158, theoretical flexural waves 160, mode-decomposition flexural processing 162, theoretical extensional waves 164, mode-decomposition extensional processing 166. The reconstructed flexural components 162 show a relatively compact early peak, however, they exhibit a long trailing signal which due to some remaining extensional contamination as well as specular signal.

In some embodiments, a first order perturbation may also be considered. For example, the nature of the medium behind the casing may not be known. For simplicity, the noise and specular reflections may still be ignored in this example, and the annular medium may be assumed to be a fluid. The real part of the wavevector may also be assumed to be represented by Equation 2 but with a different fluid-induced attenuation. The total attenuation measured by a tool may further be assumed to be the sum of the contributions from the inner fluid α_{λ}ⁱ and from the annular fluid α_{λ}^{a}, such that the wavevector κ_{λ} of the problem becomes

$${κ}_{λ} = \frac{ω}{{c}_{λ} ( ω )} + i ( {α}_{λ}^{i} + {α}_{λ}^{α} ) \\ = \frac{ω}{{c}_{λ} ( ω )} + i {α}_{λ}^{exp} , \qquad Eq . 8$$

where an effective experimental attenuation sum is defined by α_{λ}^{exp}=α_{λ}ⁱ+α_{λ}^{a}. The measurement is then described by a set of signals

$$[ \begin{matrix}{y}_{1} = {a}_{0} + {s}_{0} \\ {y}_{2} = {a}_{0} {e}^{- i {κ}_{A 0} TR} + {s}_{0} {e}^{- i {κ}_{S 0} TR}\end{matrix} , \qquad Eq . 9$$

which may be processed with an initial ‘guess’ of the dispersion relation given by Equation 2 and obtain

$$[ \begin{matrix}{a}_{0} = \frac{{y}_{1} - {e}^{i {k}_{S 0} TR} {y}_{2}}{1 - {e}^{- i ( {k}_{A 0} - {k}_{S 0} ) TR}} \\ {s}_{0} = \frac{{y}_{1} - {e}^{i {k}_{A 0} TR} {y}_{2}}{1 - {e}^{i ( {k}_{A 0} - {k}_{S 0} ) TR}}\end{matrix} \qquad Eq . 10$$

Replacing the yᵢ results in the relationships below.

$$[ \begin{matrix}{a}_{0}^{proc} = \frac{{a}_{0} + {s}_{0} - {e}^{i {k}_{S 0} TR} ( {a}_{0} {e}^{- i {κ}_{A 0} TR} + {s}_{0} {e}^{- i {κ}_{S 0} TR} )}{1 - {e}^{- i ( {k}_{A 0} - {k}_{S 0} ) TR}} \\ {s}_{0}^{proc} = \frac{{a}_{0} + {s}_{0} - {e}^{i {k}_{A 0} TR} ( {a}_{0} {e}^{- i {κ}_{A 0} TR} + {s}_{0} {e}^{- i {κ}_{S 0} TR} )}{1 - {e}^{- i ( {k}_{A 0} - {k}_{S 0} ) TR}}\end{matrix} \\ ⇔ [ \begin{matrix}{a}_{0}^{proc} = \frac{\begin{matrix}{a}_{0} ( {e}^{- i {κ}_{A 0} TR} - {e}^{- i ( δ {k}_{S 0} + {κ }_{S 0} ) TR} ) + \\ {s}_{0} ( {e}^{- i {κ}_{S 0} TR} - {e}^{- i ( δ {k}_{S 0} + {κ}_{S 0} ) TR} )\end{matrix}}{{e}^{- i ( δ {k}_{A 0} + {κ}_{A 0} ) TR} + {e}^{- i ( δ {k}_{S 0} + {κ}_{S 0} ) TR}} \\ {s}_{0}^{proc} = \frac{\begin{matrix}{a}_{0} {e}^{i ( δ {k}_{S 0} + {κ}_{S 0} ) TR} ( 1 - {e}^{iδ {k}_{A 0} TR} ) + \\ {s}_{0} {e}^{i ( δ {k}_{S 0} + {κ}_{S 0} ) TR} ( 1 - {e}^{i ( δ {k}_{A 0} + {κ}_{A 0} - {κ}_{S 0} ) TR} )\end{matrix}}{- {e}^{- i ( δ {k}_{A 0} + {κ}_{A 0} ) TR} + {e}^{i ( δ {k}_{S 0} + {κ}_{S 0} ) TR}}\end{matrix} \qquad Eq . 11$$

The ‘dispersion-error’ quantities may be introduced as below:

$$[ \begin{matrix}δ {k}_{A 0} = {k}_{A 0} - {κ}_{A 0} \\ δ {k}_{S 0} = {k}_{S 0} - {κ}_{S 0}\end{matrix} \qquad Eq . 12$$

Further, the attenuation errors may be estimated in the quantities of Equation 12. Using Equation 7, the first order in δk_{A0} and in δk_{S0} may be obtained for the flexural attenuation from the argument of a₀^{proc}e^{ik}^{_{A0}}^{TR}:

$$Ln ( {a}_{0}^{proc} {e}^{i {k}_{A 0} TR} ) ≅ i \{ {k}_{A 0} + \frac{{s}_{0}}{{a}_{0}} δ {k}_{S 0} + \frac{1}{{e}^{i ( {κ}_{A 0} - {κ}_{S 0} ) TR} - 1} ( δ {k}_{A 0} + \frac{{s}_{0}}{{a}_{0}} δ {k}_{S 0} ) \} , \qquad Eq . 13$$

and analogously for the extensional attenuation:

$$Ln ( {s}_{0}^{proc} {e}^{i {k}_{S 0} TR} ) ≅ i \{ {k}_{S 0} - δ {k}_{S 0} - \frac{1}{{e}^{i ( {κ}_{A 0} - {κ}_{S 0} ) TR} - 1} ( δ {k}_{S0} + \frac{{a}_{0}}{{s}_{0}} δ {k}_{A 0} ) \} . \qquad Eq . 14$$

With the assumption of accurate real parts

$$Re {κ}_{λ} = Re {k}_{λ} = \frac{ω}{{c}_{λ}}$$

of the wavevector estimates Equation 8,

δk_{λ}=i(α_{λ}−α_{λ}^{exp}) Eq. 15

the flexural attenuation (to first order in α_{λ}−α_{λ}^{exp}) may be determined:

$$Ln ( {a}_{0}^{proc} {e}^{i {k}_{A 0} TR} ) ≅ - \{ {α}_{A 0} + \frac{{s}_{0}}{{a}_{0}} ( {α}_{S 0} - {α}_{S 0}^{exp} ) + \frac{1}{{e}^{- ( {α}_{A 0}^{exp} - {α}_{S 0}^{exp} ) TR} - 1} ( ( {α}_{A 0} - {α}_{A 0}^{exp} ) + \frac{{s}_{0}}{{a}_{0}} ( {α}_{S 0} - {α}_{S 0}^{exp} ) ) \} . \qquad Eq . 16$$

Equation 16 above therefore represents a measure of the processing error obtained by incorrect assumptions on the Lamb wave dispersion relations. The first term on the right side is the estimated processing attenuation coefficient (a_{A0})−it is the zeroth-order result. The second and fourth terms are mixed-in weighted contributions from the extensional mode attenuation error (α_{S0}−α_{S0}^{exp}). The third term is proportional to the flexural mode attenuation error (α_{A0}−α_{A0}^{exp}), with a weighting factor that depends on the ‘true’ flexural and extensional attenuation coefficients (e^{-(α}^{_{A0}}^{^{exp}}^{-α}^{_{S0}}^{^{exp}}^{)TR}−1)⁻¹.

The above processing retains first-order sensitivity to the desired leaky Lamb-wave attenuation properties. Since all coefficients a₀^{proc} and s₀^{proc} are frequency dependent, the processing error depends on the frequency as well. This will in particular lead to a degraded temporal compactness of flexural mode with increasing error α_{λ}−α_{λ}^{exp}.

FIG. 12 shows a plot 170 of results of the present mode decomposition processing for synthetic data versus fluid acoustic impedance. The forward model used here is a real-axis integration code. A fluid-immersed plate of 22 mm thickness was simulated. A hypothetical fluid is modeled with constant ratio of compressional velocity-to-density in the external half-space (and water on the sensor side). The conventional processing result 172 shows the generally expected quasi-linear relationship between flexural attenuation and acoustic impedance. However, the perturbation by extensional mode can affect the accuracy of this result. This is represented in FIG. 12 at Zann=1.5 MRayl. The fluid on both sides of the steel is water and the conventional processing reads relatively high, at approximately 50 dB as opposed to the approximately 42 dB of pure flexural attenuation 174, while the mode decomposition 176 yields approximately 40.4 dB. Overall, the mode-decomposition technique employs a fixed dispersion relation for water throughout, imposing a biased dispersion relation everywhere but near Zann=1.5 MRayl. Therefore, as shown in the analysis of Equation 16, the zeroth-order result for the flexural attenuation is simply the approximately 42 dB imposed by the model. In some embodiments, a first order correction may be applied due to the external fluid acoustic impedance to result in the slope of attenuation versus acoustic impedance.

In some embodiments, an iterative optimization process may be implemented. An iterative process may iteratively adjust the attenuations α_{λ} in the processing (Equation 8). The process may involve using the conventional flexural wave attenuation to estimate a first estimate of the total fluid flexural attenuation, and then multiplying the frequency dependent imaginary part of the complex pole of mode λ in the asymptotic forward model by a proportionality factor to account for the first estimate of the total flexural attenuation (a). In some embodiments, the extensional mode pole can be treated in the same way. The process may then involve computing the mode-decomposition with the adjusted dispersion relation to find a second estimate of the flexural attenuation. The final value of the flexural attenuation through mode-decomposition can be approached by testing the resulting time-domain flexural mode for compactness, and/or minimizing the energy arriving after the flexural peak. Such an iteration may be accomplished by minimizing an appropriate cost function which is obvious to those working in the field. A cost function may for instance be the normalized cumulative sum of flexural wave energy in the time-domain for each spacing xₖ, as in Eq 17 below:

$${S}_{j} ( {x}_{k} ) = \frac{1}{{S}_{N} ( {x}_{k} )} {\sum }_{i = 1}^{j} {{y}_{A 0} ( {x}_{k} , {t}_{i} )}^{2} \qquad Eq . 17$$

where the total signal trace has N sample points. The width between a lower threshold and an upper threshold may be reduced.

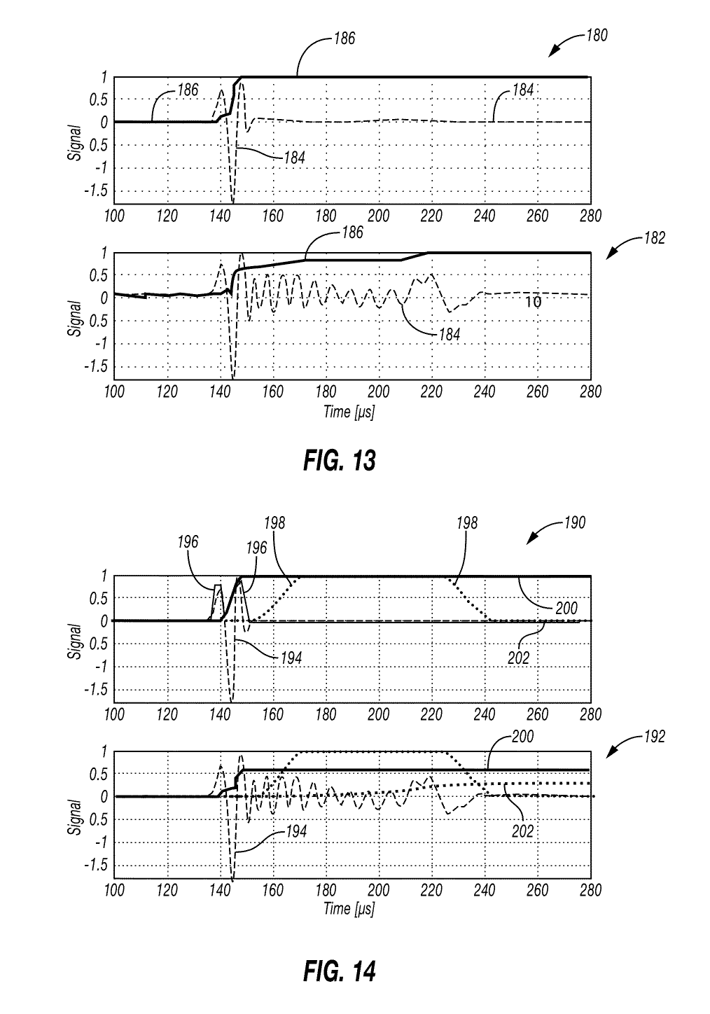

FIG. 13 plots a cost function based on the cumulative sum of squares of a waveform. The plot 180 is an example of a compact normalized flexural wave 184, the normalized cumulative sum of squares Eq 17 186 and a choice of thresholds at 10% and 90% which are reached at 140.8 μs and 147.2 μs, respectively. The plot 182 is a non-compact normalized waveform including flexural, extensional and specular signals. The thresholds are crossed at 143 μs and 218.4 μs

Alternatively, two windowed sums may be introduced for each mode λ,

$${S}_{n 1 , n 2 , λ} ( {x}_{k} ) = {\sum }_{i = n 1}^{n 2} {[ w ( {x}_{k} , {t}_{i} ) {y}_{λ} ( {x}_{k} , {t}_{i} ) ]}^{2} \\ {S}_{m 1 , m 2 , λ} ( {x}_{k} ) = {{\sum }_{i = m 1}}^{m 2} {[ w ( {x}_{k} , {t}_{i} ) {y}_{λ} ( {x}_{k} , {t}_{i} ) ]}^{2} \qquad Eq . 18$$

such that the waveform interval [n1,n2] encompass the flexural peak and the interval [m1,m2] is after the flexural peak. w(xₖ, tᵢ) are suitable window functions. The ratio of S_{n1,n2,λ}(xₖ) to S_{m1,m2,λ}(xₖ) can be minimized to find the least amount of extensional ‘leakage’ into the flexural wave.

In FIG. 14, an example for a cost function based on the windowed sum of squares of a waveform is plotted. The plot 190 is an example of a compact normalized flexural wave 194, two Tukey windows 196, 198, the normalized cumulative windowed sum of squares (Eq. 18) in each window 200, 202, respectively. The early flexural peak window sum is S_{n1,n2,λ}(xₖ)=0.97 compared to the later window sum S_{m1,m2,λ}(xₖ)=0.002. The bottom plot is a non-compact normalized waveform including flexural, extensional and specular signals. The respective sums are S_{n1,n2,λ}(xₖ)=0.61 and S_{m1,m2,λ}(xₖ)=0.27. The ratio S_{m1,m2,λ}(xₖ)/S_{n1,n2,λ}(xₖ) is thus 0.002 in the top case compared to 0.446 in the bottom case. Alternatively, the windowed sum for the flexural mode may be maximized while minimizing the extensional windowed sum in the same interval, and vice versa.

The present techniques include embodiments for unmixing first order lamb modes (anti-symmetric A0 and symmetric S0) in waveforms acquired by ultrasonic cement evaluation tools, such that a more reliable mode attenuation estimation may be performed. One embodiment involves constructing dictionaries Dₖ from the signals of each individual mode A0 and S0 (varying physical parameters as tool centering or pipe thickness) and to concatenate them in global dictionary D. In some embodiments, an acquired signal is represented as a weighted sum of dictionary elements with the help of a pursuit algorithm. Finally, individual lamb modes are reconstructed by as the weighted sum of elements belonging to each dictionary Dₖ.

As discussed, in a pitch-catch technique, an emitter sends an oblique incident pulse toward the casing, exciting predominantly the zeroth-order anti-symmetric mode A0. Concurrently, the emitted pulse excites the zeroth-order symmetric mode S0, also called the extensional mode. Both Lamb waves exhibit dispersion which means that the propagation velocity depends on the frequency. The advantage of the anti-symmetric A0 mode is that its group velocity is only weakly frequency dependent for a large range of casing thicknesses as long as the pulse is centered on a frequency of few hundred of kilohertz. Hence the measured attenuation of the flexural mode can be reliably estimated.

Although the pitch-catch technique allows for the adjustment of the transducer angles in order to maximize the flexural amplitude over the extensional amplitude, this adjustment may be less efficient through thicker casing. One or more embodiments involve using a signal processing approach that can also be applied in combination with the frequency modification mentioned above.

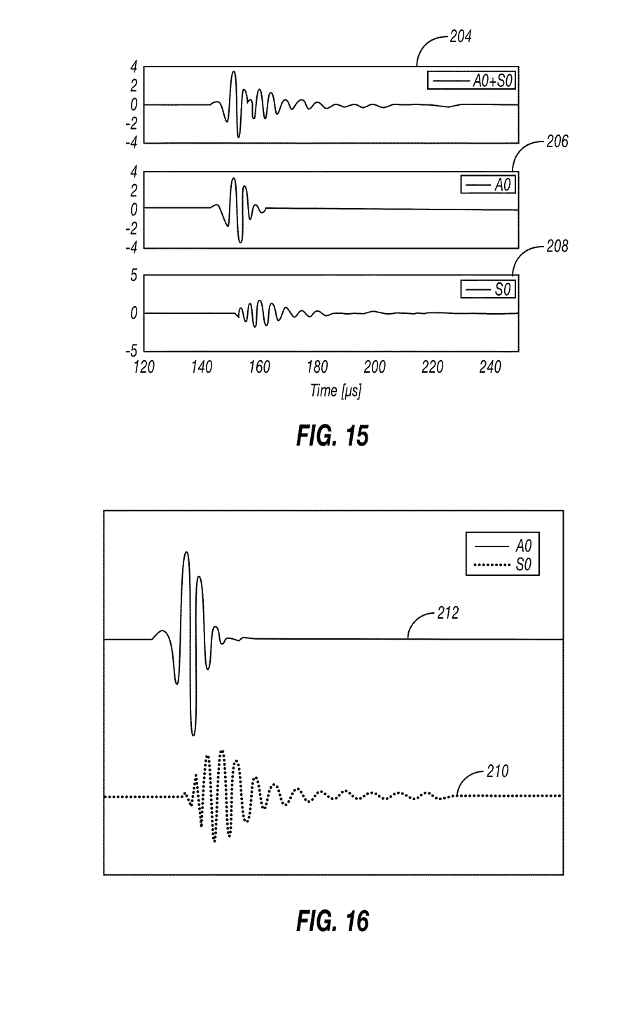

In some embodiments, the acquired signal is assumed to be the sum of two distinct A0 and S0 signals, as illustrated in plot 204 of FIG. 15 and as represented below:

x(t)=x_{A0}(t)+x_{S0}(t), t=0 . . . T. Eq. 19

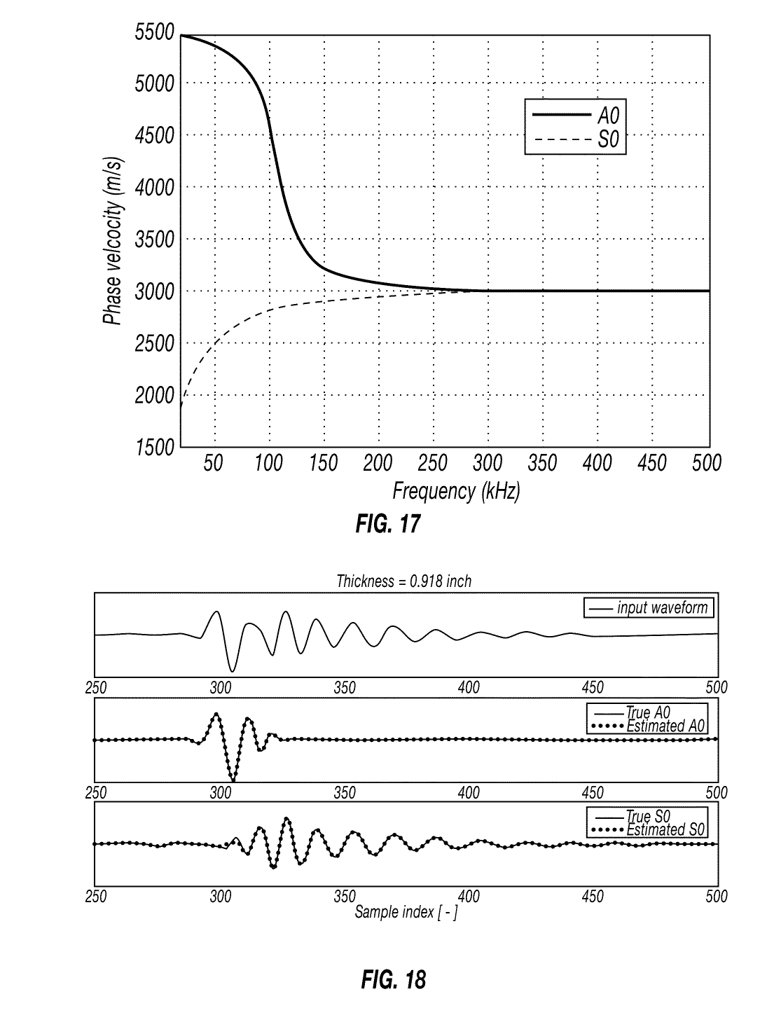

Distinct dictionaries Dₖ (k=A0 or k=S0) may be constructed for each individual mode A0 (plot 206) and S0 (plot 208). In the operating conditions of the tool (in a range of a several hundred kilohertz and casing thickness as large as 25 mm, for example), S0 210 is less compact than A0 212, as represented by FIG. 16, and more dispersive with a strongly frequency dependent propagation speed, as represented by FIG. 17. As such, the dictionaries D_{A0} and D_{S0} are expected to have moderate mutual coherence.

The two dictionaries may then be concatenated in a global dictionary D.

D=[D_{A0}|D_{S0}] Eq. 20

Then, an acquired signal may be represented as a weighted sum of dictionary elements with the help of a pursuit algorithm to solve the minimization problem

$${min}_{α} {‖ α ‖}_{0} subject to {‖ x - D α ‖}_{2} \leq ɛ \qquad Eq . 21$$

An Orthognal Matching Pursuit has been used in this example, but any other algorithm solving could be used.

The individual lamb mode signals may then be reconstructed as the weighted sum of elements belonging to each dictionary Dₖ

x_{A0}=D_{A0}α_{1|2} and x_{S0}=D_{S0}α_{2|2} Eq. 22

An example of the decomposition is given in FIG. 16 for a 14-in casing with 0.918-in thickness

Finally, the method is applied on data acquired by both near and far receivers and the flexural attenuation can be estimated from the two estimated signals as x_{A0,near} and x_{A0,far}.

$$α = 20 {log}_{10} ( \frac{\vert {x}_{A 0 , near} \vert}{\vert {x}_{A 0 , far} \vert} ) \text{/} d ( near , far ) \qquad Eq . 23$$

While the embodiments are described with reference to various implementations and exploitations, it will be understood that these embodiments are illustrative and that the scope of the inventive subject matter is not limited to them. Many variations, modifications, additions and improvements are possible. For example, additional sources and/or receivers may be located about the wellbore to perform seismic operations.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
receiving acoustic cement evaluation data into a data processing system, wherein the acoustic cement evaluation data is obtained from one or more acoustic downhole tools used over a depth interval in a well having a casing, wherein the acoustic cement evaluation data comprises leaky-Lamb wave measurements measured from the one or more acoustic downhole tools;
applying a mode decomposition technique on the leaky-Lamb wave measurements, wherein the mode decomposition technique comprises:
determining an extensional mode component of the leaky-Lamb wave measurements; and
determining a flexural mode component of the leaky-Lamb wave measurement; and
determining a flexural wave attenuation based on the flexural mode component of the leaky-Lamb wave measurement.

2. The method of claim 1, wherein applying the mode decomposition technique further comprises estimating errors due to casing curvature, specular reflection, fluid attenuation, noise, or combinations thereof.

3. The method of claim 2, wherein applying the mode decomposition technique further comprises correcting the errors in determining the flexural wave attenuation.

4. The method of claim 1, comprising applying an iterative adjustment to iteratively adjust the flexural wave attenuation.

5. The method of claim 1, wherein determining the extensional mode component is based on an imaginary component of the leaky-Lamb wave measurements.

6. The method of claim 1, wherein determining the extensional mode component comprises determining a dispersion relation of the leaky-Lamb wave measurements.

7. The method of claim 1, wherein determining the flexural mode component comprises determining a real component of the leaky-Lamb wave measurement.

8. The method of claim 1, wherein determining the flexural wave attenuation is further based on a cost function of a normalized flexural mode component, a normalized extensional mode component, and a normalized spectral component, or combinations thereof.

9. The method of claim 1, wherein determining the flexural wave attenuation is further based on a cost function of a sum of squares of the leaky-Lamb measurements.

10. The method of claim 1, wherein the leaky-Lamb wave measurements are measured by two or more receivers of the one or more acoustic downhole tools.

11. A method comprising:
receiving acoustic cement evaluation data into a data processing system, wherein the acoustic cement evaluation data is obtained from one or more acoustic downhole tools used over a depth interval in a well having a casing, wherein the acoustic cement evaluation data comprises leaky-Lamb wave measurements from the one or more acoustic downhole tools;
determining an extensional mode component of the leaky-Lamb wave measurement;
determining a flexural mode component of the leaky-Lamb wave measurement;
constructing a dictionary for each of the extensional mode component and the flexural mode component, wherein the dictionaries comprise parameters related to the casing and the one or more acoustic downhole tools;
representing the leaky-Lamb wave measurement as a weighted sum based on the dictionaries; and
reconstructing a flexural wave attenuation based on the weighted sum.

12. The method of claim 11, further comprising concatenating the dictionaries of the extensional mode component and the flexural mode component in a global dictionary.

13. The method of claim 12, wherein representing the leaky-Lamb wave measurement as the weighted sum comprises representing the leaky-Lamb wave measurement as the weighted sum of the global dictionary.

14. The method of claim 11, wherein representing the leaky-Lamb wave measurement as the weighted sum comprises using a pursuit algorithm.

15. The method of claim 11, wherein the one or more receivers comprises two or more receivers, and wherein the processor further comprises instructions for applying the leaky-Lamb wave measurement from each of the two or more receivers to reconstruct the flexural wave attenuation.

16. One or more tangible, non-transitory computer-readable media comprising instructions to:
receive acoustic cement evaluation data from one or more acoustic downhole tools used in a depth interval of a well having a casing, wherein the acoustic cement evaluation data comprises Lamb wave measurements from the one or more acoustic downhole tools;
determine an extensional mode component of the Lamb wave measurement;
determine a flexural mode component of the Lamb wave measurement; and
determine a flexural wave attenuation based on the flexural mode component of the Lamb wave measurement.

17. The computer-readable media of claim 16, further comprising instructions to apply a mode decomposition technique on the Lamb wave measurements.

18. The computer-readable media of claim 17, further comprising instructions to apply an iterative adjustment to iteratively adjust the flexural wave attenuation.

19. The computer-readable media of claim 16, further comprising instructions to construct a dictionary for each of the extensional mode component and the flexural mode component, wherein the dictionaries comprise parameters related to the casing and the one or more acoustic downhole tools.

20. The computer-readable media of claim 19, further comprising instructions to represent the Lamb wave measurement as a weighted sum based on the dictionaries and reconstruct a flexural wave attenuation based on the weighted sum.
